(19) United States
(12) Patent Application Publication
(10) Pub. No.: US 2019/0315170 A1
(43) Pub. Date: Oct. 17, 2019

(54) Wireless Trailer Signal System

(71) Applicant: Clinton Williams, Green Cove Springs, FL (US)

(72) Inventor: Clinton Williams, Green Cove Springs, FL (US)

(21) Appl. No.: 16/382,304

(22) Filed: Apr. 12, 2019

Related U.S. Application Data
(60) Provisional application No. 62/657,092, filed on Apr. 13, 2018.

(51) Int. Cl. B60D 1/62; H04W 4/80; B60R 16/023; H04W 4/48

(52) U.S. Cl. CPC B60D 1/62; H04W 4/48; B60R 16/023; H04W 4/80

(57) ABSTRACT

A wireless trailer signal system. The system includes a transmitter attachable to a vehicle, and a receiver attachable to a trailer to be towed by the vehicle. The transmitter is operably connected to an electrical system of the vehicle and is wirelessly connected to the receiver. The receiver is operably connected to an electrical system of the trailer. During use, the transmitter receives a signal (e.g., a turn signal or a brake signal) from the electrical system of the vehicle, and wirelessly transmits the signal to the receiver, which operates one or more lights connected to the electrical system of the trailer.

### CROSS REFERENCE TO RELATED APPLICATIONS

This application claims priority under 35 U.S.C. § 119(e) to U.S. Provisional Application No. 62/657,092 filed on Apr. 13, 2018. The above identified patent application is incorporated by reference herein in its entirety to provide continuity of disclosure.

### BACKGROUND OF THE INVENTION

The present invention relates to a wireless trailer signal system for wirelessly transmitting a signal from a vehicle to a trailer towable by the vehicle.

Ordinary connection systems for use with a vehicle and a trailer towable by the vehicle are used to ensure that surrounding drivers are notified of brakes, turns, and emergencies by the vehicle towing the trailer, but they often cause a number of complications and problems for many individuals who use these systems. These systems require an individual to properly outfit the trailer with an electrical system containing light signals for signaling brakes and turns, and to properly connect the electrical system of the trailer to an electrical system of the vehicle, such that a turn signal, a brake signal, an emergency signal, and the like, are correctly transmitted to the trailer and are correctly displayed with lights positioned on the trailer. Performing these installation steps properly is error prone, and moreover, a wired connection between the vehicle and the trailer may wear or fail with extended use.

Therefore, there is a need in the art for a wireless trailer signal system for wirelessly transmitting a signal from a vehicle to a trailer towable by the vehicle. The present invention addresses this unmet need.

Systems have been disclosed in the art that relate to trailer signal systems. These include systems that have been patented and published in patent application publications. These systems are often wired, and provided little or no convenience or durability to a user in need of a convenient and reliable system for connecting the electrical systems of a vehicle and a trailer. In view of the systems disclosed in the art, it is submitted that there is a need for an improvement to existing trailer signal systems. In view of the present disclosure, it is submitted that the present invention substantially diverges in structural and functional elements from systems in the art, and substantially fulfills an unmet need in the art.

### SUMMARY OF THE INVENTION

In view of the disadvantages inherent in the known types of trailer signal systems in the art, the present invention provides a new and improved wireless trailer signal system, wherein the same can be utilized for conveniently and reliably connecting a vehicle to a trailer, such that the trailer conveys signals received from the vehicle using one or more lights of an electrical system installed to the trailer.

It is therefore an object of the present invention to provide a wireless trailer signal system for wirelessly transmitting a signal from a vehicle to a trailer towable by the vehicle.

In one aspect, the present invention provides a wireless trailer signal system comprising a transmitter operably connected to an electrical system of a vehicle, and a receiver operably connected to an electrical system of a trailer towable by the vehicle. The transmitter is wirelessly connected to the receiver to wirelessly transmit a signal from the vehicle to the trailer. In this manner, a wired connection between the vehicle and the trailer is not needed to use one or more brake lights, one or more turn signal lights, or one or more other lights, such as emergency lights, in a manner that is consistent with a use of the corresponding systems of the vehicle (i.e., braking, use of turn signals, and use of emergency lights).

In another aspect, the present invention provides a wireless trailer signal system comprising a transmitter operably connected to an electrical system of a vehicle via a wired connection to a trailer connector of the vehicle, and a receiver operably connected to an electrical system of a trailer towable by the vehicle, wherein the transmitter is wirelessly connected to the receiver. Generally, the electrical system of the vehicle is configured to transmit a signal to the transmitter, which is configured to transmit the signal to the receiver. The receiver is configured to interpret the signal to activate or deactivate one or more lights operably connected to the electrical system of the trailer.

In some embodiments, the operable connection between the receiver and the electrical system of the trailer includes a wired connection between a battery of the receiver and the one or more lights, due to the fact that the receiver is wirelessly connected to the transmitter, and may not receive electricity to power the lights of the trailer. In some embodiments, the battery is rechargeable, and may be operably connected to a solar panel configured to recharge the battery.

In some embodiments, the transmitter is configured to transmit a radio signal to the receiver. In such embodiments, the transmitter may utilize a Bluetooth® frequency, such as between about 2.400 gigahertz and about 2.485 gigahertz, for the radio signal. In this manner, the transmitter can wirelessly communicate with the receiver using existing wireless technology, thereby simplifying manufacture and use of the wireless trailer signal system.

Another object of the present invention is to provide a wireless trailer signal system that may be readily manufactured from materials that permit relative economy and are commensurate with durability.

A further object of the present invention is to provide a wireless trailer signal system that removes the need for a physical electrical connection between the towing vehicle and the trailer the vehicle tows.

Yet another object of the present invention is to provide a wireless trailer signal system that senses light status on the towing vehicle and transmits remote status messages via a transmitter to a receiver on the trailer being towed, wherein the receiver and trailer lights are powered by a rechargeable battery.

Still a further object of the present invention is to provide a wireless trailer signal system that can monitor lights for faults such as open wires, shorted wires, or burned out lights, as well as monitor the battery charge level, and communicate the information to the operator of the system.

Other objects, features and advantages of the present invention will become apparent from the following detailed description taken in conjunction with the accompanying drawings.

### BRIEF DESCRIPTIONS OF THE DRAWINGS

Although the characteristic features of the invention will be particularly pointed out in the claims, the invention itself and manners in which it may be made and used may be better understood after a review of the following description, taken in connection with the accompanying drawings, wherein like numeral annotations are provided throughout.

FIG. 1 depicts a perspective view of a wireless connection between a transmitter on a vehicle and a receiver on a trailer towable by the vehicle, with an inset view showing the positioning of various components.

FIG. 2 depicts a perspective view of the transmitter and the receiver of the exemplary wireless trailer signal system.

FIG. 3 depicts a perspective view of the transmitter of the exemplary wireless trailer signal system.

FIG. 4 depicts a perspective view of the receiver of the exemplary wireless trailer signal system.

FIG. 5 depicts a perspective view of the transmitter of the exemplary wireless trailer signal system operably connected to an electrical system of the vehicle.

FIG. 6 depicts a perspective view of the receiver of the exemplary wireless trailer signal system operably connected to an electrical system of the trailer.

FIG. 7 depicts a schematic diagram of the components of the exemplary wireless trailer signal system.

FIG. 8 depicts a perspective view of the transmitter of the exemplary wireless trailer signal system.

FIG. 9 depicts a perspective view of the receiver of the exemplary wireless trailer signal system.

FIG. 10 depicts a schematic diagram of the transmitter of the exemplary wireless trailer signal system.

FIG. 11 depicts a schematic diagram of the receiver of the exemplary wireless trailer signal system.

### DETAILED DESCRIPTION OF THE INVENTION

Reference is made herein to the attached drawings. Like reference numerals are used throughout the drawings to depict like or similar elements of the invention. The figures are intended for representative purposes only and should not be considered limiting in any respect.

Reference is now made to the drawings, which depict one or more exemplary embodiments of the invention.

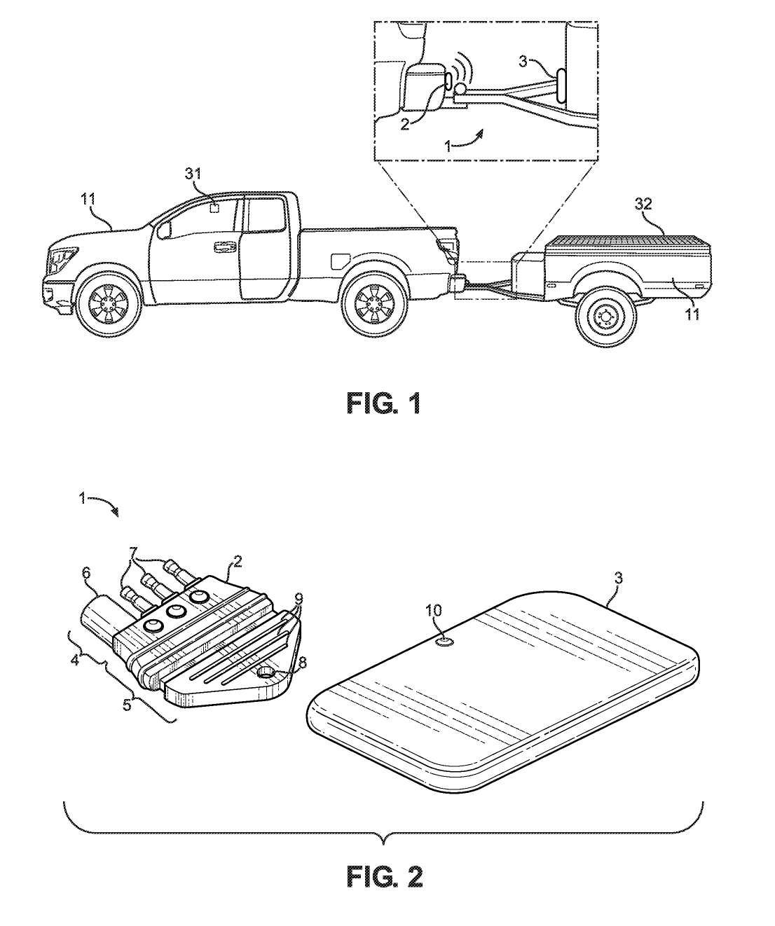

Referring now to FIG. 1, there is depicted a side perspective view of an exemplary wireless trailer signal system according to the present invention. The inset depicts a close-up perspective view of a wireless connection between a transmitter on a vehicle and a receiver on a trailer towable by the vehicle. Generally, a wireless trailer signal system 1 includes a transmitter 2 operably connected to an electrical system of a vehicle 11, and a receiver 3 operably connected to an electrical system of a trailer 12 towable by the vehicle 11. The transmitter 2 is wirelessly connected to the receiver 3. The receiver 3 may be powered by a rechargeable battery, which in some embodiments may be recharged via a solar panel 32 disposed on the trailer 11. Further, the receiver 3 is configured to communicate wirelessly with an external device 31, such as a smartphone for example, which may be utilized to display status messages regarding the trailer lights and other components of the system.

In particular embodiments, the transmitter 2 is operably connected to the electrical system of the vehicle 11 via a wired connection to a trailer connector of the vehicle 11, and the receiver 3 is operably connected to the electrical system of the trailer 12 towable by the vehicle 11. The electrical system of the vehicle 11 is configured to transmit a signal to the transmitter 2, the transmitter 2 is configured to transmit the signal to the receiver 3, and the receiver 3 is configured to interpret the signal to activate or deactivate one or more lights operably connected to the electrical system of the trailer 12. In one aspect, the absence of electrical wires between the vehicle 11 and the trailer 12 may provide an extended lifetime to the components of the present system, in contrast to a wired coupling system, which wears out or becomes damaged or destroyed upon exposure to weather or use.

Accordingly, it is envisioned that the present invention be composed of materials and design elements that render the wireless trailer signal system 1 to be resistant or sufficiently proofed against weather, including but not limited to rain, wind, low temperatures, and flooding. Accordingly, in some embodiments, one or more components of the wireless trailer signal system 1 is encased within a housing that is waterproof, watertight, or airtight, and an interior of the housing of the one or more components is fluidly isolated from an exterior of the housing. In this manner, the wireless trailer signal system 1 is sufficiently weatherproof and rugged so as to survive extended use and inclement weather events, and a lifetime of the components of the present invention is extended or maximized.

In the shown embodiment, the transmitter 2 is attachable to a portion of the vehicle 11, such as the trailer connector, and the receiver 3 is attachable to a portion of the trailer 12, such as a forward surface of the trailer 12. In this manner, a distance between the transmitter 2 and the receiver 3 is minimized, and a radio signal, such as a high-frequency radio signal, may be sent by a radio transmitter of the transmitter 2, which may be received by a radio receiver of the receiver 3. In this manner, a risk of data loss during transfer of the signal from the transmitter 2 to the receiver 3 is minimized, and a risk of interference with surrounding radio systems is minimized. In some embodiments, the radio signal sent by the radio transmitter of the transmitter 2 is a Bluetooth® signal, and as such, may have a frequency between about 2.400 gigahertz and about 2.485 gigahertz.

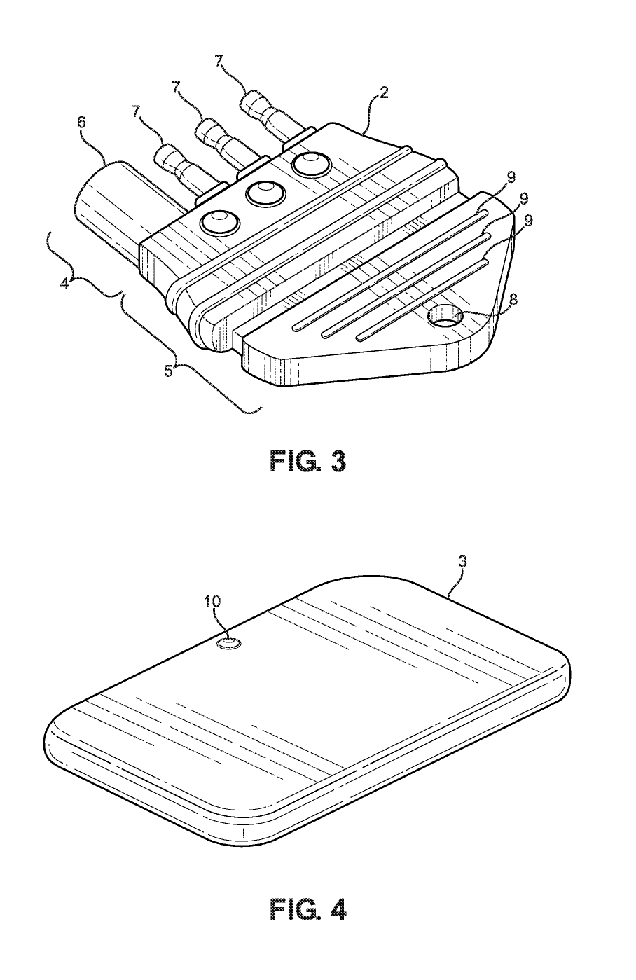

Referring now to FIGS. 2-4, there are depicted a perspective view of the transmitter and the receiver, a perspective view of the transmitter, and a perspective view of the receiver of the exemplary wireless trailer signal system. In the shown embodiment, the transmitter 2 includes a base portion 5 with a prong portion 4 that extends therefrom. In the shown embodiment, the prong portion 4 includes a grounding prong 6 and a plurality of circuit prongs 7, and three circuit prongs 7 are utilized. In addition, in the shown embodiment, the base portion 5 includes a plurality of grips 9 thereon, as well as an aperture 8 for additional uses of the transmitter 2. Exemplary additional uses include, but are not limited to, attachment of the transmitter 2 to a structure such as a key ring, or insertion of an item through the aperture 8 to facilitate insertion or removal of the transmitter 2 into or from the trailer connector of the vehicle, respectively. In the shown embodiment, the receiver 3 includes a housing having a button 10 thereon, which may be used to access an interior of the housing of the receiver 3.

In various embodiments, the operable connection between the receiver 3 and the electrical system of the trailer includes a wired connection between a battery of the receiver 3 and the one or more lights, for example, as may be attached to the trailer. In such embodiments, the receiver 3 includes the battery, which may be a rechargeable battery, within the interior of the housing of the receiver 3. In this manner, the receiver 3, and components thereof and attached thereto, are powered by the battery, rather than an electrical current delivered from the electrical system of the vehicle. In such embodiments, the wireless trailer signal system may further comprise a solar panel that is operably connected to the receiver 3, and that is configured to recharge the battery. The solar panel may be any size or configuration suited for this purpose, and it is envisioned that the solar panel may be positioned on, attached to, or installed to the trailer. Generally, in such embodiments, the solar panel converts energy from the environment, such as solar energy from the sun, into electrical energy which is stored in the rechargeable battery. Accordingly, in such embodiments, the wireless trailer signal system may be used continuously or extensively, without needing to replace the battery, or without needing to stop the vehicle to recharge the battery.

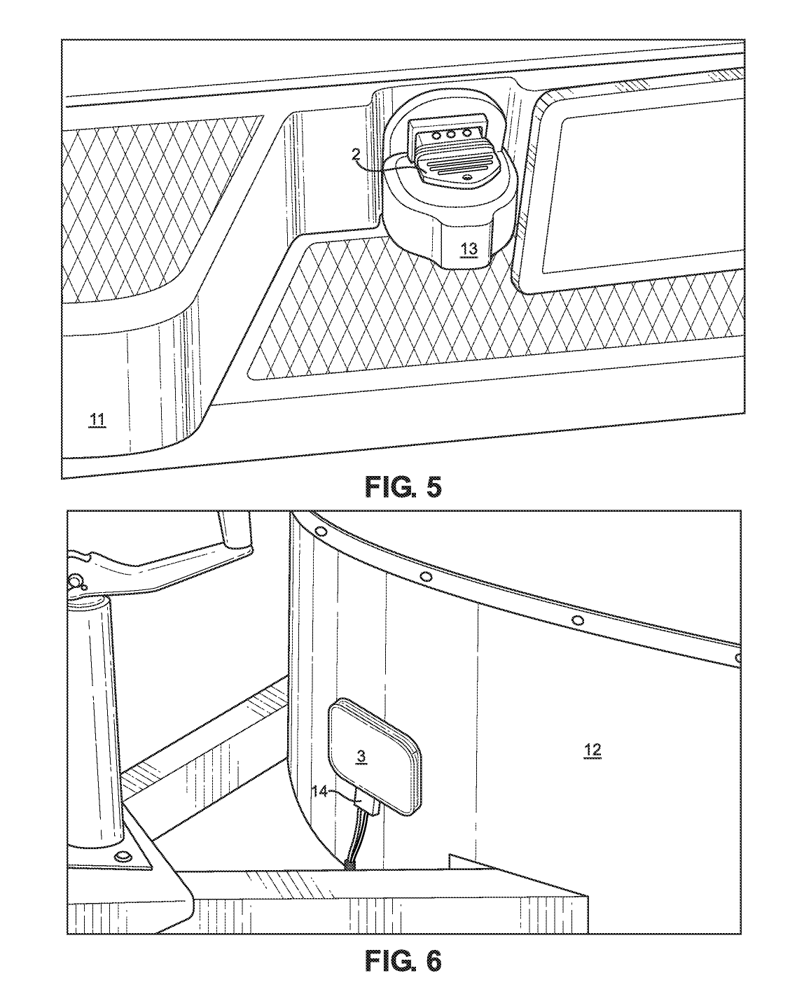

Referring now to FIGS. 5 and 6, there are depicted a perspective view of the transmitter of the exemplary wireless trailer signal system, operably connected to an electrical system of the vehicle, and a perspective view of the receiver of the exemplary wireless trailer signal system, operably connected to an electrical system of the trailer, respectively. In the shown embodiment, the transmitter 2 is operably connected to the trailer connector 13 of the vehicle 11. In this manner, the present invention may be used with existing trailer connectors in the art, and requires minimal configuration for use. In addition, in the shown embodiment, the receiver 3 is operably connected to the electrical system 14 of the trailer 12, and is shown mounted to the forward surface of the trailer 12. In various embodiments, the receiver 3 may be configured to be secured to the trailer 12 by one or more suitable fasteners.

The electrical system 14 includes one or more lights, including but not limited to brake lights, turn signal lights, and emergency lights, operably connected thereto. In the shown embodiment, the receiver 3 includes an interface that accepts the electrical system 14 therein, to electrically couple the battery of the receiver 3 to components of the electrical system 14. In various embodiments, the interface of the receiver 3 may be used with existing electrical systems 14 in the art, and requires minimal configuration for use. In this manner, the convenience and the utility of the present invention are maximized. Generally, the present invention provides a wireless trailer signal system that may be configured for use with existing vehicles, trailers, and related systems, and represents a substantial contribution to the art of vehicle-trailer signaling which mitigates many of the drawbacks and disadvantages of previous systems used for this purpose.

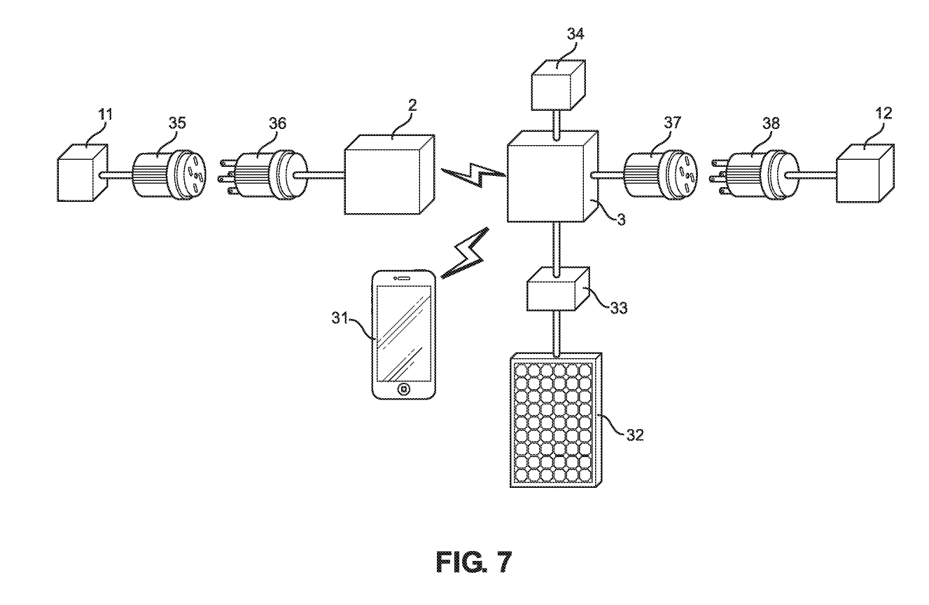

Referring now to FIG. 7, there is shown a schematic diagram of the components of the exemplary wireless trailer signal system. The transmitter 2 is operably connected to the vehicle 11 electrical system via the vehicle to trailer electrical connector 35, 36. The transmitter 2 is in wireless communication with the receiver 3, which is powered via the battery system 34. The battery system 34 is operably connected to a charging mechanism 33, which may include a solar panel 32 mounted to the vehicle. The receiver 3 is operably connected to the trailer 12 via the trailer to vehicle electrical connector 37, 38. Further, the receiver 3 is configured to communicate wirelessly with a smartphone 31 in order to send and display light status and overall system status for the operator to monitor.

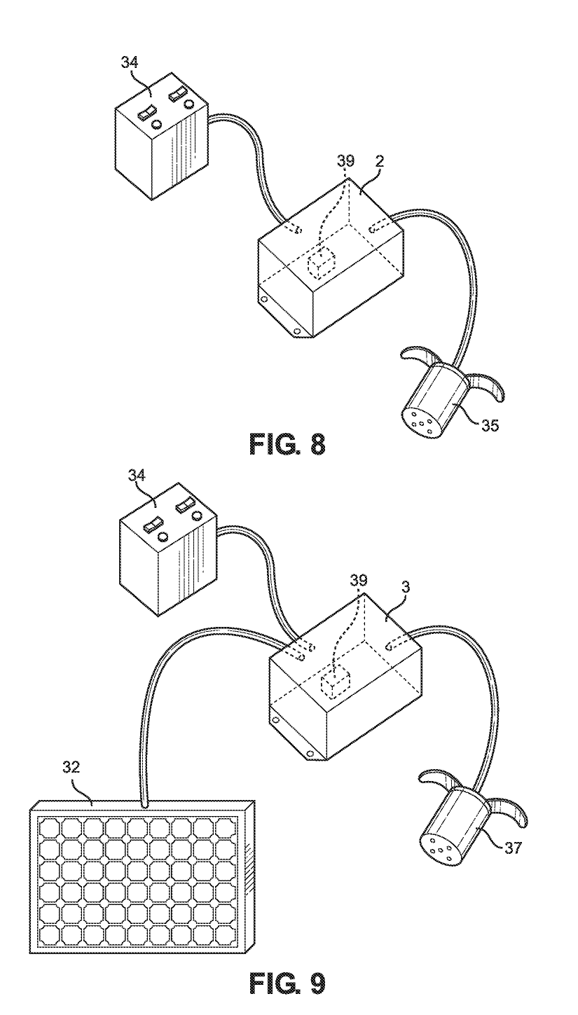

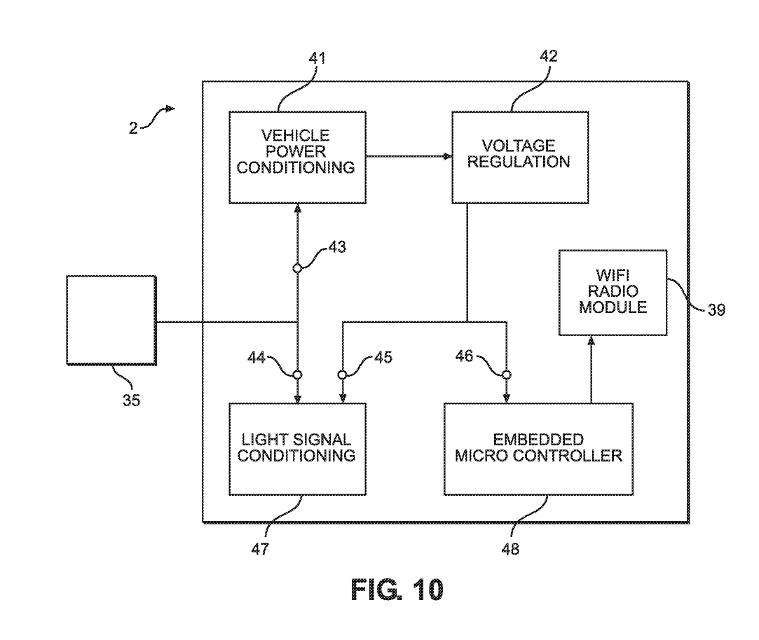

Referring now to FIGS. 8 and 10, there is shown a perspective view of the transmitter of the exemplary wireless trailer signal system and a schematic diagram of the transmitter of the exemplary wireless trailer signal system, respectively. The transmitter 2 is secured to the towing vehicle and includes a wireless transceiver 39 that is configured to wirelessly communicate with the receiver secured to the trailer. In the shown embodiment, the wireless transceiver 39 is a self-contained 802.11 Wifi transceiver that can maintain a link with the receiver and communicate with it securely, using passwords and encryption to secure communications. The transmitter 2 further includes a connection 35 to the electrical system of the vehicle 11, such that the transmitter 2 can monitor the status of the vehicle lights. In one embodiment, connection 35 is a connection to the towing vehicle using the vehicle's pre-existing trailer electrical connectors. In this embodiment, the transmitter 2 is powered via this connection, or ultimately via the vehicle battery. In other embodiments, the transmitter 2 is powered via a battery 34 which may be any other suitable type of rechargeable battery.

The transmitter 2 further includes a vehicle power conditioning module 41 that is configured to protect the transmitter 2 from various transient conditions that can exist within the towing vehicle's power system. The vehicle power conditioning module 41 is configured to limit the voltage of the system and prevent it from breaching a maximum safe level, while a voltage regulation module 42 operably connected to the conditioning module 41 is configured to provide necessary voltages for the circuitry of the transmitter 2. The vehicle power conditioning module 41 is also operably connected to a light signal conditioning module 47 which is configured to provide voltage reduction and transient protection for the light signals from the towing vehicle. Overload devices limit the voltage that can appear on the transmitter 2 input connections and can absorb excess energy. The circuitry can additionally include various power nodes 43, 44, 45, 46 where power is received and levels are checked. A second layer of protection further limits the voltage and protects an embedded microcontroller 48 from damage due to transient electrical events.

The embedded microcontroller 48 is configured to cause a wireless transceiver to transmit light signals from the towing vehicle to the receiver on the trailer. In one embodiment, the embedded microcontroller 48 is an STM32F0 processor which is configured to read light signals from the towing vehicle. The embedded microcontroller 48 is configured to poll the receiver and receive information therefrom, such as trailer light status or trailer battery status, and provide that information to the operator. To that end, the embedded microcontroller 48 is further configured to link to a control device such as a smartphone, either via a web page or a software application, to allow for monitoring of the system by the smartphone user.

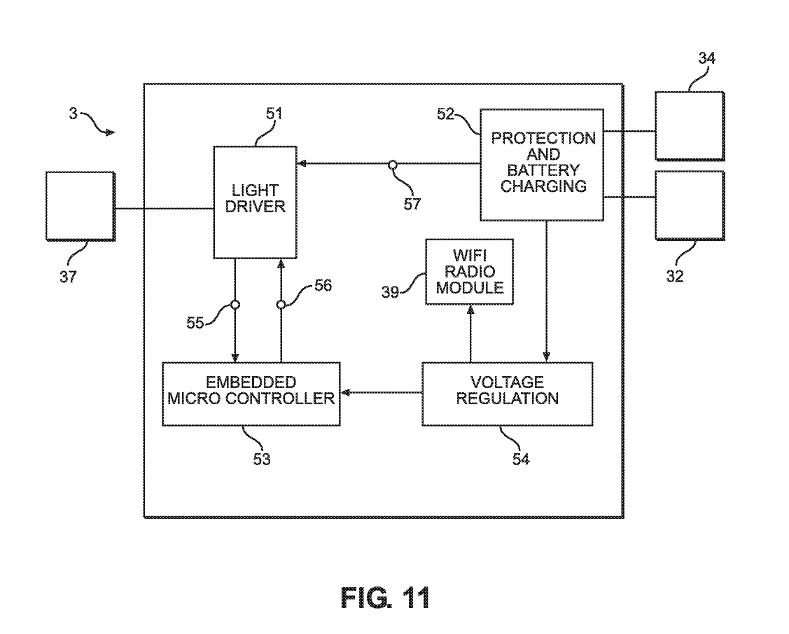

Referring now to FIGS. 9 and 11, there is shown a perspective view of the receiver of the exemplary wireless trailer signal system and a schematic diagram of the receiver of the exemplary wireless trailer signal system, respectively. The receiver 3 is secured in or on the trailer and connects to the trailer via the vehicle electrical connector 37 of the trailer. The receiver 3 is powered by the rechargeable battery 34, which is in turn able to be charged via the solar panel 32. The receiver 3 is configured to receive signals from the transmitter and turn the trailer lights on or off based upon the received signals. The receiver 3 can monitor the connections to the trailer lights and can detect fault conditions and battery status, which are then provided to the transmitter 2.

The receiver 3 includes a protection and battery charging module 52 that provides reverse polarity protection on the battery leads and allows for monitoring of the battery charge condition. In one embodiment, the system includes a large rechargeable battery 34 and one or more battery charging modules 52. The battery 34 can be any rechargeable chemical, lead-acid, gel cell, LI-ION, or any other suitable type of battery. In the shown embodiment, the battery can be charged via a solar panel 32 mounted on the trailer, or can be charged via a stand-alone AC adapter. The battery charging module 52 is further operably connected to a voltage regulation module 54 that is configured to provide the voltages required for the circuitry in the receiver 3. The battery charging module 52 provides power 57 to a light driver 51, which includes dedicated LED driver integrated circuits that can power the trailer lights as well as monitor the current being drawn by the trailer lights. In the illustrated embodiment, the light driver 51 is operably connected to an embedded microcontroller 53, such as an STM32F0 processor, which handles the process of sending and receiving messages to and from the transmitter 2 via the wireless transceiver 39, which is a 802.11 Wifi transceiver in the shown embodiment. The embedded microcontroller 53 can receive light status 55 signals from the light driver 51, and can send the light signals 56 as determined by the transmitter 2 to the light driver 51 to control the output of the trailer lights.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

I claim:

1) A wireless trailer signal system, comprising:
a transmitter operably connected to an electrical system of a vehicle;
a receiver operably connected to an electrical system of a trailer towable by the vehicle;
wherein the transmitter is wirelessly connected to the receiver;
wherein the receiver is configured to be secured to the trailer by one or more fasteners.

2) The wireless trailer signal system of claim 1, wherein the electrical system of the vehicle is configured to transmit a signal to the transmitter, wherein the transmitter is configured to transmit the signal to the receiver, wherein the receiver is configured to interpret the signal to activate or deactivate one or more lights operably connected to the electrical system of the trailer.

3) The wireless trailer signal system of claim 1, wherein the transmitter is attached to a portion of the vehicle, wherein the receiver is attached to a portion of the trailer.

4) The wireless trailer signal system of claim 3, wherein the portion of the vehicle includes a trailer connector.

5) The wireless trailer signal system of claim 3, wherein the portion of the trailer includes a forward surface of the trailer.

6) The wireless trailer signal system of claim 1, wherein the operable connection between the transmitter and the electrical system of the vehicle includes a wired connection, wherein the operable connection between the receiver and the electrical system of the trailer includes a wired connection.

7) The wireless trailer signal system of claim 6, wherein the operable connection between the transmitter and the electrical system of the vehicle is configured to transmit an electrical current from the electrical system of the vehicle to the transmitter, wherein the electrical current powers the transmitter and communicates one or more signals from the electrical system of the vehicle to the transmitter.

8) The wireless trailer signal system of claim 1, wherein the transmitter is configured to transmit a wireless signal to the receiver.

9) The wireless trailer signal system of claim 8, wherein the wireless signal includes a radio signal.

10) The wireless trailer signal system of claim 9, wherein the radio signal has a frequency between about 2.400 gigahertz and about 2.485 gigahertz.

11) A wireless trailer signal system, comprising:
a transmitter operably connected to an electrical system of a vehicle via a wired connection to a trailer connector of the vehicle;
a receiver operably connected to an electrical system of a trailer towable by the vehicle;
wherein the transmitter is wirelessly connected to the receiver;
wherein the electrical system of the vehicle is configured to transmit a signal to the transmitter;
wherein the transmitter is configured to transmit the signal to the receiver;
wherein the receiver is configured to interpret the signal to activate or deactivate one or more lights operably connected to the electrical system of the trailer;
wherein the receiver is configured to be secured to the trailer by one or more fasteners.

12) The wireless trailer signal system of claim 11, wherein the operable connection between the receiver and the electrical system of the trailer includes a wired connection between a battery of the receiver and the one or more lights.

13) The wireless trailer signal system of claim 12, wherein the battery is rechargeable.

14) The wireless trailer signal system of claim 13, further comprising a solar panel operably connected to the receiver and configured to recharge the battery.

15) The wireless trailer signal system of claim 14, wherein the transmitter is configured to transmit a radio signal to the receiver.

16) The wireless trailer signal system of claim 15, wherein the radio signal has a frequency between about 2.400 gigahertz and about 2.485 gigahertz.
